(19) United States
(12) Patent Application Publication
(10) Pub. No.: US 2010/0110531 A1
(43) Pub. Date: May 6, 2010

(54) Reflective Full Color Display

(75) Inventors: Charles O. Edwards, Rio Rancho, NM (US); James Caruso, Albuquerque, NM (US)

Correspondence Address: PEACOCK MYERS, P.C., 201 THIRD STREET, N.W., SUITE 1340, ALBUQUERQUE, NM, 87102, US

(73) Assignee: TRED Dispalys, Inc., Albuquerque, NM (US)

(21) Appl. No.: 12/624,330

(22) Filed: Nov. 23, 2009

Related U.S. Application Data
(63) Continuation-in-part of application No. 11/862,886, filed on Sep. 27, 2007.
Application No. 11/862,886 is a continuation-in-part of application No. 11/860,198, filed on Sep. 24, 2007.
(60) Provisional application No. 61/116,977, filed on Nov. 21, 2008.

(51) Int. Cl. G02F 1/19

(52) U.S. Cl. 359/296

(57) ABSTRACT

Reflective color displays. Each pixel or sub-pixel of the display preferably comprises at least one magneto-optical element that can rotate in more than two stable positions, displaying a color corresponding to each position. Thus each element can display more than one color (in addition to black, if desired). Multiple elements may be combined to form a sub-pixel and/or pixel. The displays are preferably highly light reflective and preferably have low power consumption and increased resolution.

### CROSS-REFERENCE TO RELATED APPLICATIONS

This application claims the benefit of the filing of U.S. Provisional Patent Application Ser. No. 61/116,977, entitled “Highly Reflective Full Color Display”, filed on Nov. 21, 2008. This application is also a continuation-in-part application of U.S. patent application Ser. No. 11/860,198, entitled “Reflective, Bi-Stable Magneto Optical Display Architectures”, filed on Sep. 24, 2007, and U.S. patent application Ser. No. 11/862,886, entitled “Magneto-Optical Display Elements”, filed on Sep. 27, 2007. The specifications and claims of these applications are incorporated herein by reference.

### BACKGROUND OF THE INVENTION

1. Field of the Invention (Technical Field)

The present invention comprises methods and devices for reflective color displays, wherein each sub-pixel preferably comprises at least one magneto-optical element that can rotate in more than two stable positions, with corresponding colors, thereby forming a multi-stable (i.e. having more than 2 stable states) display. Such displays are preferably highly light reflective and preferably have low power consumption and increased resolution.

2. Description of Related Art

Traditional color displays such as liquid crystal, plasma and LED displays have sub-pixel and pixel architectures such that each sub-pixel can only produce one color, for example G or green (or be turned off and display black or K), as shown in FIG. 1. K denotes black, W is white, R is red, G is green and B is blue. Each pixel comprises more than one single-color sub-pixels. This pixel design is fundamentally limited because it has limited color combinations and also operates best as a light emitting display. While a theoretical fully reflective digital RGB display architecture as shown in FIG. 1 has a theoretical maximum reflectivity of 33⅓% (because only one third of each pixel can be a desired color), a reflective LCD display only has about 16% or less reflectivity due to the loss of light resulting from the use of polarizing layers in the display.

### BRIEF SUMMARY OF THE INVENTION

An embodiment of the present invention is a reflective display comprising display elements, wherein the smallest display element can display more than one color. The smallest display element preferably comprises a magneto-optical element. The magneto-optical element is preferably rotatable by a magnetic field, preferably comprises two or more stable states, and/or preferably comprises a solid shape and more than one color on a surface of the solid shape. The magneto-optical element optionally comprises a magnet within the solid shape. The number of poles of the magnet is the same as the number of colors on the surface. The magneto-optical element optionally comprises a magnetic material extruded with one or more outer colored layers. The magnetic material optionally comprises a magnetic powder blended with a plastic. At least one area of a color on the surface is preferably uninterrupted. The reflective display preferably further comprises a mask for at least partially masking off from a viewer one or more areas of color adjacent to a desired display color area or a lens for magnifying a desired color area.

Two or more smallest display elements optionally comprise a pixel. The reflectivity of the pixel is preferably greater than approximately 16%, more preferably greater than 34%, even more preferably greater than approximately 50%, and most preferably greater than approximately 70%. Each pixel preferably comprises a plurality of sub-pixels, each of which preferably comprises one or more magneto-optical elements each having a same color configuration. Each of the magneto-optical elements preferably comprises four colors, the four colors comprising black, white, and two colors selected from the group consisting of red, green, and blue. Each of the primary colors is preferably disposed on the surface between the black and white colors. Each pixel optionally comprises three sub-pixels, wherein the first sub-pixel comprises one or more magneto-optical elements each comprising the colors red, black, green, and white; the second sub-pixel comprises one or more magneto-optical elements each comprising the colors red, black, blue, and white; and the third sub-pixel comprises one or more magneto-optical elements each comprising the colors green, black, blue, and white. The color of each subpixel is preferably selected to enhance a resolution of the display.

An embodiment of the present invention is a reflective display having a reflectivity of greater than approximately 16%, preferably greater than approximately 34%, more preferably greater than approximately 50%, and even more preferably greater than approximately 70%. The display is preferably a full color display.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate several embodiments of the present invention and, together with a description, serve to explain the principles of the invention. The drawings are only for the purpose of illustrating one or more particular embodiments of the invention and are not to be construed as limiting the invention. In the drawings:

FIG. 1 shows pixel and sub-pixel architectures known in the art.

FIG. 2 shows a four-color magneto-optical element (MOE) of one embodiment of the present invention. The element on the right comprises four magnetic poles.

FIG. 3 shows a pixel comprising a plurality of MOE sub-pixels.

FIG. 4 shows MOEs configured to produce a high reflectivity display sub-pixel.

FIG. 5 shows a view of a pixel comprising three sub-pixels, each sub-pixel comprising three of the MOEs shown below each sub-pixel.

FIG. 6 compares colors generated by an embodiment of the present invention with those generated by a traditional RGB display.

FIG. 7 shows the ability of an embodiment of the present invention to display a large number of shades of a desired color.

FIG. 8 shows the display of a portion of an object on both a LCD pixel and a MOE-based pixel in accordance with embodiments of the present invention.

### DETAILED DESCRIPTION OF THE INVENTION

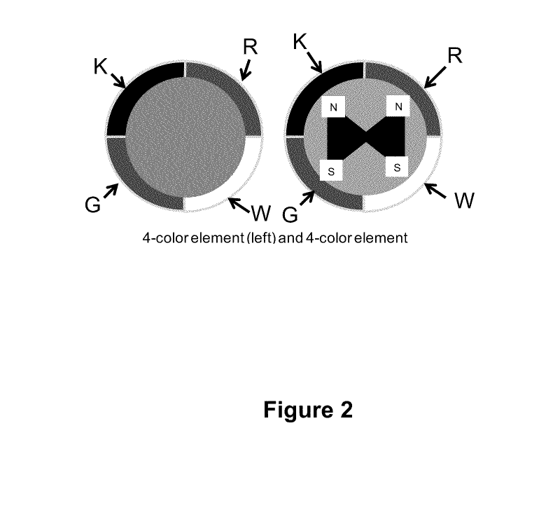

One embodiment of the present invention comprises a reflective display wherein each pixel comprises a rotating magneto-optical element (MOE) with more than two optical states. These optical states preferably comprise different colors, although they may comprise other optical characteristics, for example amount of gray-scale or optical layers which may comprise optical effects such as, for example, mirrors, luminescent materials, or color and black and white pigments. As shown in FIG. 2, this MOE may comprise, for example, four color states and comprise a four-pole permanent magnet. The four poles are preferably arranged as shown in FIG. 2, although other arrangements may be used, including but not limited to two dipole, quadrupole, or quadra-pole magnet configurations. Such four pole MOEs can present four different colors by rotation about their center axis to produce four color or full color display devices. Alternatively, the MOEs can be rotated by an external magnetic field, such as a printed circuit board comprising metallic coils, externally applied magnets, inductive magnetic coils, and/or a scanning magnetic or electromagnetic actuator array.

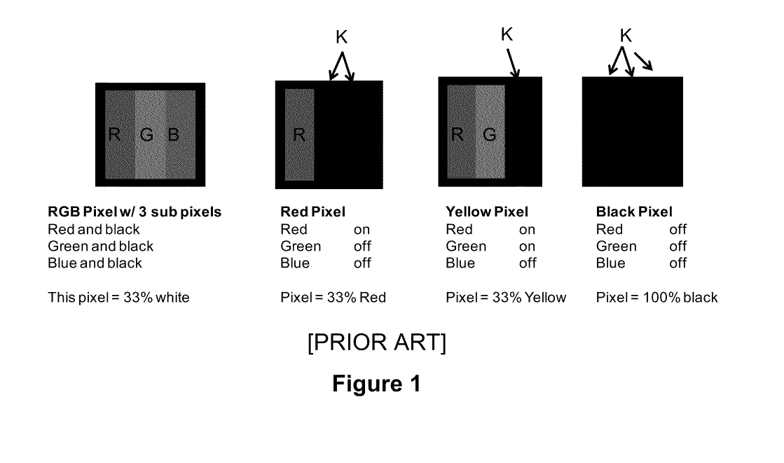

Thus the smallest display element of an embodiment of the present invention, a single MOE, can present more than one color (for example, black and three other colors) in a single sub-pixel, in contrast with the smallest display element in a traditional RGB display, a sub-pixel, which can display either black (off) or a single color, as shown in FIG. 1. These MOEs can thus comprise a highly reflective four color display. Although four colors are shown in FIG. 2, any number of colors may be employed on a single MOE. As can be seen, each color field on the MOE is uninterrupted; i.e. no visual line bisects or otherwise runs through a color field on the MOEs of the present invention. The only lines are lines between color fields (which occur every 90 degrees in the example embodiment shown in FIG. 2).

As used throughout the specification and claims, the term “smallest display element” means a sub-pixel, pixel, MOE, display element or the like, and/or the location thereof, which cannot be divided further into smaller display elements. As used throughout the specification and claims, the term “color” means color, tint, shade, gray-scale level, pigment, optical effect, and the like. As used throughout the specification and claims, the term “more than one color” means more than one color when activated and not off, or alternatively means more than one color and black.

An MOE of the present invention may have any aspect ratio, and may comprise any shape. As used throughout the specification and claims, the term “solid shape” means a cylinder, rectangular parallelepiped, prism, right prism, right circular cylinder, cube, cuboid, hexagonal parallelepiped, any cylindrical or preferably regular rectangular solid or polygonal prism, and the like.

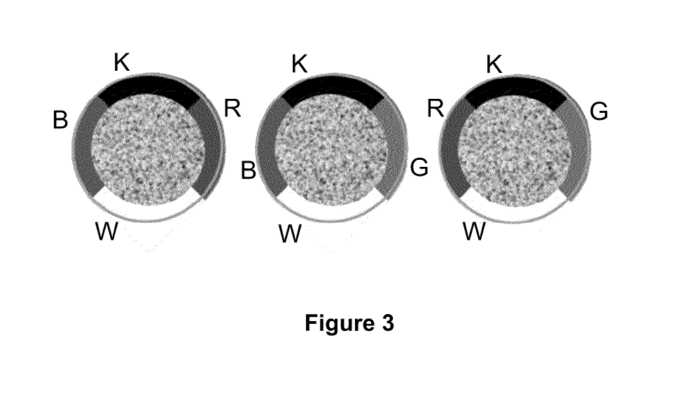

Such MOEs may optionally be used together to produce various sub-pixels, pixels and displays. As shown in FIG. 3, three different four pole four-color MOEs each act as a sub-pixel, where the leftmost MOE is RGWK, the middle MOE is RBWK, and the rightmost MOE is GBWK. This configuration may be used to construct a full color display device or another optical device requiring simple indicators or areas of target color not necessarily considered a graphic display. Displays produced with these elements may be used for indoor and outdoor information displays, digital signage displays and advertising (for example billboards).

The multi-pole MOEs comprising more than one color described herein can be produced in a number of ways, including but not limited to mechanical insertion of magnetic structures into structures having more than one color, or a coloration step on top of a magnetic structure. A preferred method comprises an extrusion process whereby a magnetic structured core is co-extruded with the outer colored layers or layers. The magnetic material preferably comprises a permanent magnetic material such as a ferrite, ceramic magnetic material or a rare-earth magnetic powder (such as Neodymium Iron Boron (Nd₂Fe₁₄B) or Samarium Cobalt, (SmCo₅)). This magnetic material is preferably blended with a plastic like Nylon, POM or similar. Magnetic powder is typically isotropic, making it easy to use in pelletization and extrusion processes. The extruded material can be magnetized by the application of a high-strength magnetic field sufficiently strong enough to orient the domains of the magnetic material.

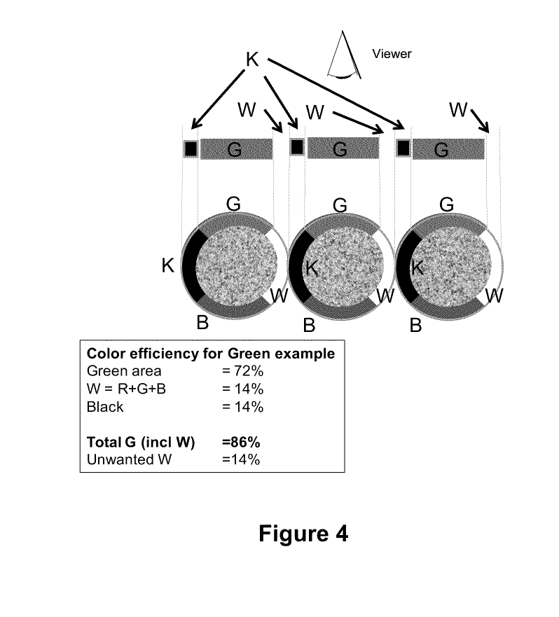

An embodiment of the present invention comprises a display having a reflectivity greater than approximately 34%. The four pole four color MOE geometry shown in FIG. 4, with W and K on the sides adjacent to the colors, results in 86% total reflectance of the target color with only 14% white contamination (addition of white into the green color). This is due to the fact that the viewing angle of each MOE is greater than the 90° arc of each color. By keeping the W and K sides adjacent to the color sides, color contamination between the two colors is avoided. Here, the K and W create a net “grey” effect that slightly decreases the target color saturation but does not impact the hue. This results in a greater than twice improved white and greater than 1.5 times the color saturation over traditional RGB reflective pixels as shown in FIG. 1. Alternatively a faceplate-type structure or overlay may optionally be used to mask off the unwanted colors, or a lens may be disposed between the viewer and the MOE to magnify only the desired color and not the adjacent colors.

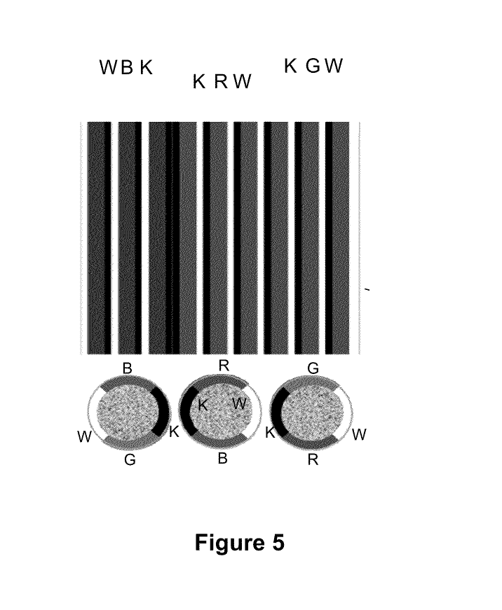

Such MOEs can be combined to form a full color display. The MOE pixel architecture shown in FIG. 5 comprises three sub-pixels (RGWK, RBWK, and GBWK) which combined make up a complete pixel. Because each MOE comprises only four colors (one for each 90 degree rotation/MOE position, each sub-pixel in this embodiment is missing one of the primary colors. For example, the GBKW MOE is missing red (R). This configuration can negatively impact color saturation of pure primary colors. However, the net reflectivity efficiency is much higher than the theoretical maximum 33⅓% reflectivity per color of traditional reflective RGB displays. The largest efficiency gain is in the black and white image component. For traditional RGB pixels, white has a maximum reflectivity of only 33⅓%, but in this embodiment of the present invention, when each four-color MOE displays white, pixel white can achieve approximately 72% reflectivity. (This is less than 100% due to approximately 28% contamination from adjacent colors being visible to the viewer, as discussed above.) Furthermore, embodiments of the present invention do not require the use of polarizers (as in LCD displays), which can reduce reflectivity by 50% or more.

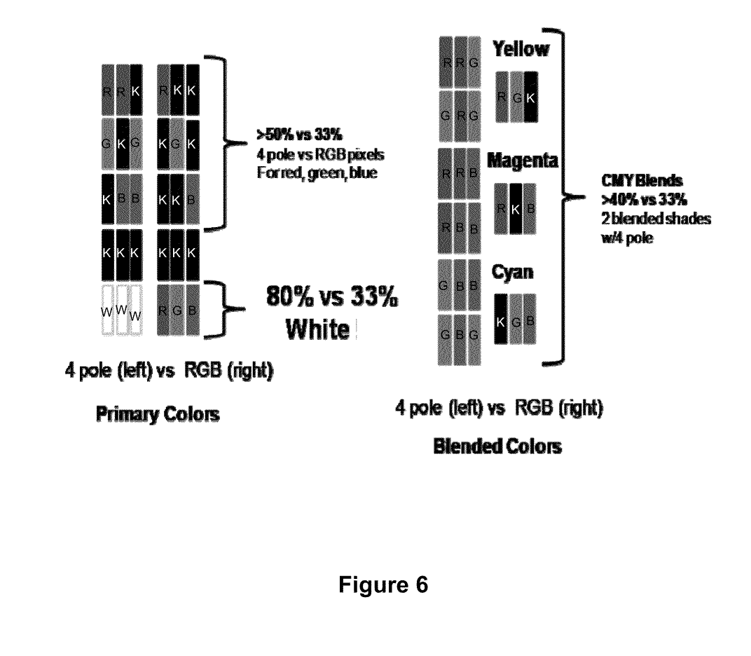

Another embodiment of the present invention is a display comprising more than four color pixel states. If each MOE has four different color states (for example RGKW), many more combinations of MOE sub-pixels are available for generating shades of color. As shown in FIG. 6, this embodiment comprises a pixel design with each pixel comprising three four pole MOEs, each MOE comprising four colors: two of the three RGB colors, black, and white. With this design there are 64 available pixel states. By adding more MOEs per pixel or sub-pixel, more combinations are achievable to provide a larger number of pixel states. A traditional RGB architecture can have only eight states (assuming bi-stable, solid-color sub-pixels). This provides significantly increased color rendering, especially regarding color brightness due to enhanced reflectivity as discussed above.

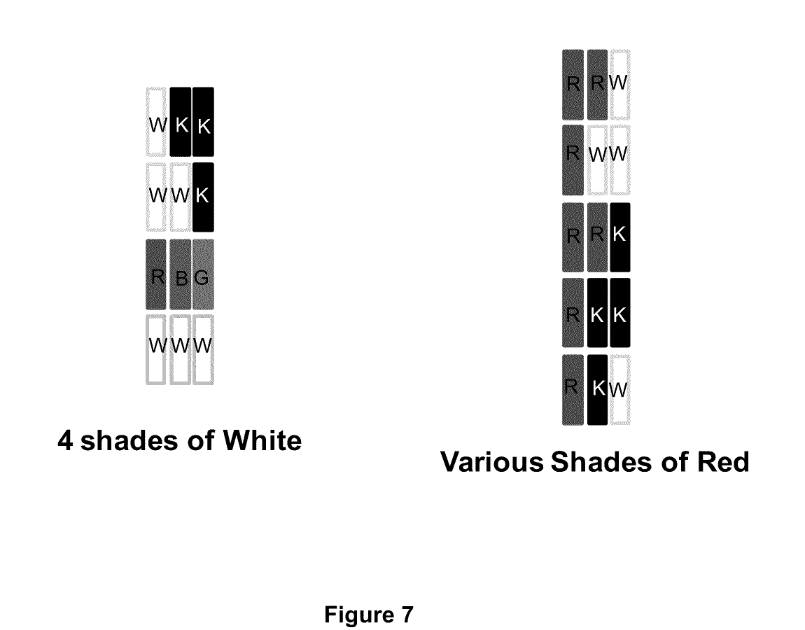

The 64 available pixel states resulting from the combination of three four-color sub-pixels enables various blends and shades of color to be displayed, as shown in FIG. 7. Thus displays according to various embodiments of the present invention have the ability to more closely match desired colors and grey scales. As discussed above, typical RGB display pixels each comprise sub-pixels which can each generate only one color or black (turned off).

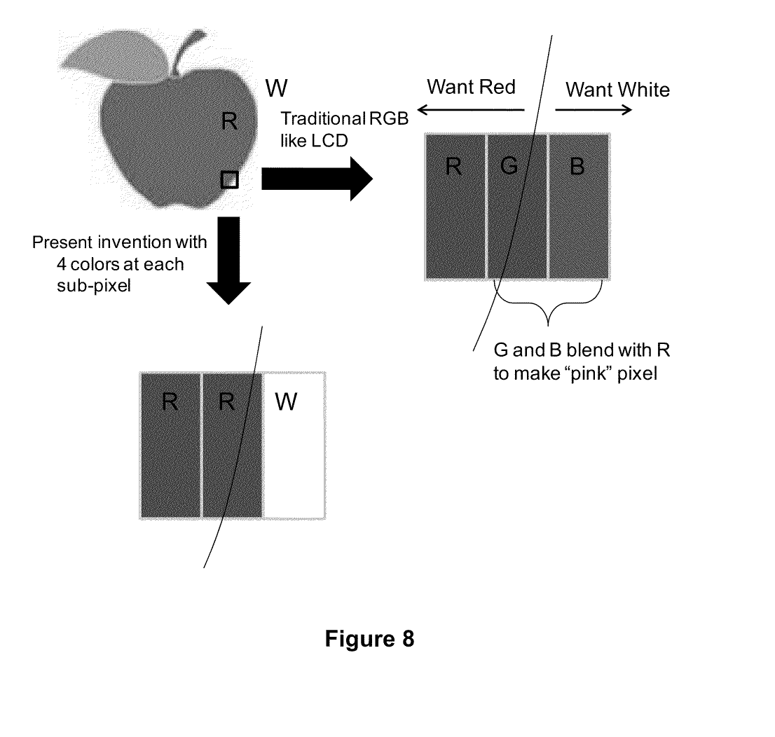

Because each sub-pixel preferably comprises more than one color state, embodiments of the present invention may comprise enhanced image resolution compared to other display technologies with the same pixel and sub-pixel sizes. As shown in FIG. 8, the edge of a red apple against a white background is displayed on both a traditional RGB LCD display pixel and a 4-color MOE-based display pixel in accordance with embodiments of the present invention. For the LCD display, pixels are generally considered a single optical value and the three sub-pixels are blended into a single optical color. For this example, in which the red apple/white background transition cuts through the LCD pixel's center green sub-pixel, the red, green blue pixels typically work together and blend (for example 50% B, 50% G, 100% R) to produce pink, not red on the left of the pixel and white in the balance of the pixel. In contrast, for the MOE-based pixel, since each sub-pixel can produce more than one color the left and center sub-pixels can be red and the right sub-pixel can be white.

The display architectures comprising smallest display elements or locations each able to display more than one color in accordance with embodiments of the present invention enables the development of new imaging algorithms and stochastic image analysis. These algorithms and stochastic image analysis can also be used in other new display technologies, for example electrostatic displays or layered filter-based displays. Such stochastic analysis can take into account the more than one color states of each MOE, sub-pixel and/or pixel, increasing performance of displays in such areas as reflectivity, color purity and resolution. For example, as shown in FIG. 8, sub-pixels can accommodate the geometry of the apple edge cutting across the pixel and enhance the detail and color values within the pixel. This may be accomplished by intelligently selecting the colors used in each sub-pixel. Using advanced error-diffusion or stochastic algorithms it may also be possible to eliminate the entire three RGB sub-pixels per full color pixel structure with MOE-based displays disclosed herein. By distributing all three types of MOE color pixels evenly over the display it may be possible to use an error diffusion (or stochastic) algorithm to display images using each MOE-based smallest display element (e.g. a single MOE) as a distinct pixel rather than a sub-pixel of a larger pixel.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents, references, and publications cited above are hereby incorporated by reference.

What is claimed is:

1. A reflective display comprising display elements, wherein the smallest display element can display more than one color.

2. The reflective display of claim 1 wherein said smallest display element comprises a magneto-optical element.

3. The reflective display of claim 2 wherein said magneto-optical element is rotatable by a magnetic field.

4. The reflective display of claim 3 wherein said magneto-optical element comprises two or more stable states.

5. The reflective display of claim 2 wherein said magneto-optical element comprises a solid shape and more than one color on a surface of said solid shape.

6. The reflective display of claim 5 wherein said magneto-optical element comprises a magnet within the solid shape.

7. The reflective display of claim 6 wherein a number of poles of said magnet is the same as a number of colors on said surface.

8. The reflective display of claim 5 wherein said magneto-optical element comprises a magnetic material extruded with one or more outer colored layers.

9. The reflective display of claim 8 wherein said magnetic material comprises a magnetic powder blended with a plastic.

10. The reflective display of claim 5 wherein an area of a color on said surface is uninterrupted.

11. The reflective display of claim 5 further comprising a mask for at least partially masking off from a viewer one or more areas of color adjacent to a desired display color area or a lens for magnifying a desired color area.

12. The reflective display of claim 5 wherein two or more smallest display elements comprise a pixel.

13. The reflective display of claim 12 wherein a reflectivity of said pixel is greater than approximately 16%.

14. The reflective display of claim 13 wherein a reflectivity of said pixel is greater than approximately 34%.

15. The reflective display of claim 14 wherein a reflectivity of said pixel is greater than approximately 50%.

16. The reflective display of claim 15 wherein a reflectivity of said pixel is greater than approximately 70%.

17. The reflective display of claim 12 wherein each pixel comprises a plurality of sub-pixels.

18. The reflective display of claim 17 wherein each said sub-pixel comprises one or more magneto-optical elements each having a same color configuration.

19. The reflective display of claim 17 wherein each of said magneto-optical elements comprises four colors, said four colors comprising black, white, and two colors selected from the group consisting of red, green, and blue.

20. The reflective display of claim 19 wherein each of said primary colors is disposed on said surface between said black and white colors.

21. The reflective display of claim 19 wherein each pixel comprises three sub-pixels;
wherein a first sub-pixel comprises one or more magneto-optical elements each comprising the colors red, black, green, and white;
a second sub-pixel comprises one or more magneto-optical elements each comprising the colors red, black, blue, and white; and
a third sub-pixel comprises one or more magneto-optical elements each comprising the colors green, black, blue, and white.

22. The reflective display of claim 21 wherein a color of each subpixel is selected to enhance a resolution of said display.

23. A reflective display having a reflectivity of greater than approximately 16%.

24. The reflective display of claim 23 having a reflectivity of greater than approximately 34%.

25. The reflective display of claim 24 having a reflectivity of greater than approximately 50%.

26. The reflective display of claim 25 having a reflectivity of greater than approximately 70%.

27. The reflective display of claim 23 wherein said display is a full color display.
